(19) United States
(12) Patent Application Publication
(10) Pub. No.: US 2013/0166333 A1
(43) Pub. Date: Jun. 27, 2013

(54) MONITORING SYSTEM FOR PARKING SPACE

(71) Applicants: HSIN-PEI CHANG, New Taipei (TW); ZONG-YUAN SUN, New Taipei (TW); DA-HUA XIAO, Shenzhen (CN)

(72) Inventors: HSIN-PEI CHANG, New Taipei (TW); ZONG-YUAN SUN, New Taipei (TW); DA-HUA XIAO, Shenzhen (CN)

(21) Appl. No.: 13/693,047

(22) Filed: Dec. 4, 2012

(30) Foreign Application Priority Data
Dec. 24, 2011 (CN) 201110438363.X

(51) Int. Cl. G08G 1/14; G06Q 10/02

(52) U.S. Cl. CPC G08G 1/142; G06Q 10/02
USPC 705/5; 340/10.1

(57) ABSTRACT

A monitoring system for a parking space includes a number of radio frequency identification (RFID) tags, a monitor, a data transceiver, and a data center. The monitor corresponds to one of the parking spaces and is positioned in the parking space. When the monitor identifies an RFID tag within the parking space, the monitor records an occupied state of the parking space. When the monitor identifies the RFID tag is no longer within the parking space, the monitor records a vacant state of the parking space. The data center communicates with the monitors using the data transceiver, and stores the vacant state and/or the occupied state of the parking space.

### BACKGROUND

1. Technical Field

The disclosure generally relates to monitoring systems for parking spaces, and particularly to a monitoring system for parking space employing radio frequency identification (RFID) technology.

2. Description of Related Art

The number of cars in cities continues to grow, resulting in rising demands for parking spaces. A car park is commonly divided into many different zones and managed by staff of the car park. However, it is time-consuming and often laborious for motorists to locate a vacant parking space, especially in a huge car park. Therefore, parking efficiency is low, and which may even cause management confusion in the car park.

It is desirable to have a system capable of managing a parking facility, such as a system that monitors parking spaces and guides a vehicle to an available parking space.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a block diagram of a monitoring system for managing parking spaces, according to an exemplary embodiment.

FIG. 2 is a schematic view of the parking space of FIG. 1.

FIG. 3 is a flowchart of a parking process of the monitoring system of FIG. 1, according to an exemplary embodiment.

### DETAILED DESCRIPTION

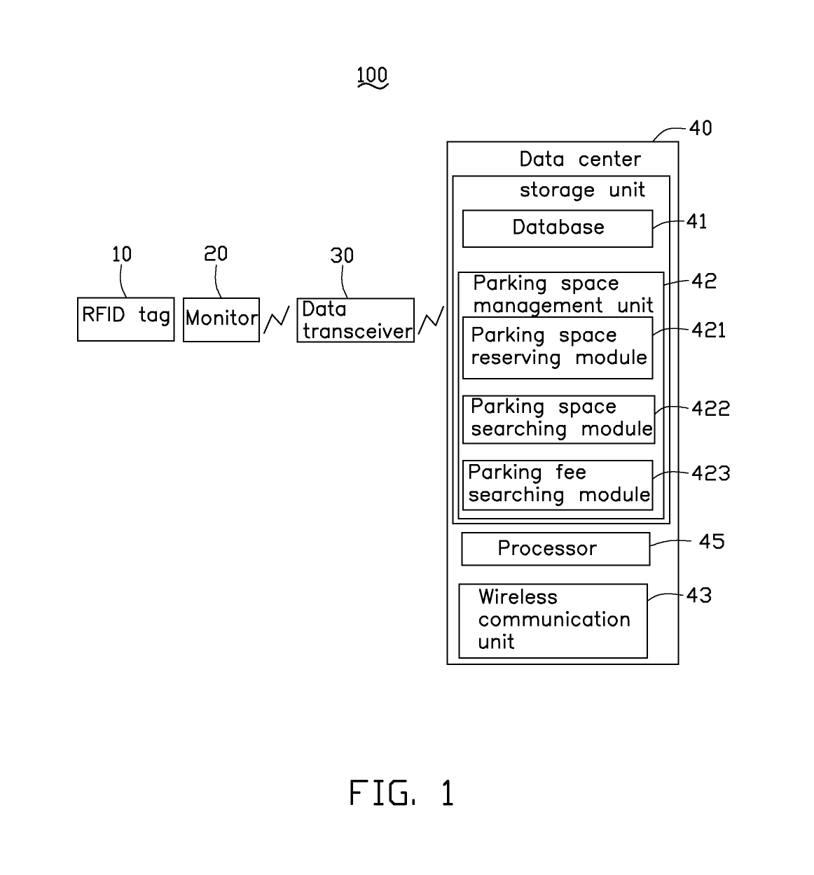

FIG. 1 shows a block diagram of a monitoring system 100 for managing parking spaces, according to an exemplary embodiment. The monitoring system 100 includes a plurality of radio frequency identification (RFID) tags 10, a plurality of monitors 20, a data transceiver 30, and a data center 40.

The RFID tags 10 store information of cars and owners of the cars. One RFID tag 10 is attached to one car.

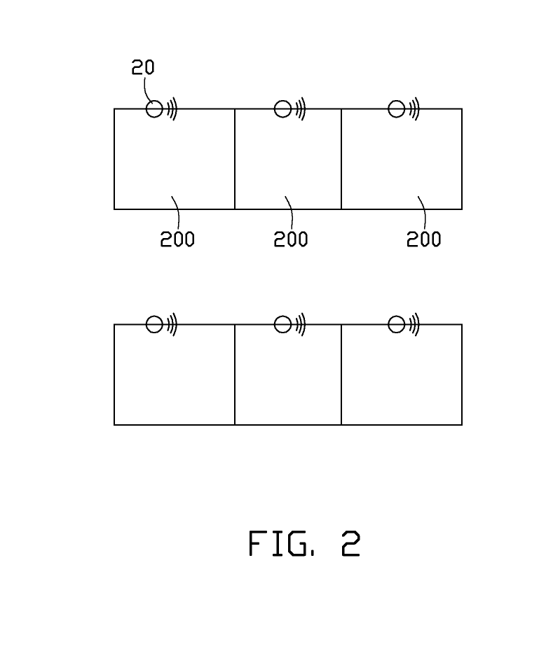

In FIG. 2, the monitors 20 may include an RFID reader which can identify the RFID tags 10. The monitors 20 are positioned at or near parking spaces 200 of a parking area. At least one monitor 20 is positioned at one parking space 200. Each monitor 20 includes a sealed waterproof metal case. The monitors 20 can be buried in the ground or embedded in walls or in structures such as steel tubes of the parking area. The metal case serves as an antenna for transmitting and receiving signals to strengthen signal intensities and is configured not to mask the signals.

Each monitor 20 is configured to monitor a car parking at a parking space 200 and recording information such as a parking start time of the car, a parking end time of the car and a state of the parking space 200, such as an occupied state, a vacant state, or a restricted or reserved state.

For example, when the monitor 20 identifies one of the RFID tags 10 within the parking space 200 (i.e. the RFID reader of the monitor 20 identifies or reads one of the RFID tags 10 within the parking space 200), the monitor 20 records the parking start time and also records that the parking space 200 is now occupied. Accordingly, once the monitor 20 loses contact with the RFID tag 10 within the parking space 200 (i.e. the RFID of the monitor 20 cannot identify or read the RFID tag 10 within the parking space 200), the determination is made that the car of the RFID tag 10 has left the parking space 200, and the monitor 20 records the parking end time and also records that the parking space 200 is now vacant. In addition, the monitor 20 obtains a parking duration time according to the parking start time and the parking end time.

The monitor 20 comprises a wireless communication function and forms a network with the data transceiver 30 and the data center 40 to timely send the parking information of the parking space 200 and the state of the parking space 200 to the data center 40 using the network. Therefore, the monitors 20 can be suitable for both monitoring and managing a centralized parking area having a single entry point such as an underground parking area and a distributed parking area having open entry, or no entry point, such as a curbside parking area.

In one exemplary embodiment, each monitor 20 may further include an ultrasonic sensor. Each monitor 20 can determine the state of each parking space 200 by sensing a distance between a car and the parking space 200. In addition, the ultrasonic sensor includes two probes configured to sense the distance to the car. When one probe is hampered or impeded by objects such as leaves or trash, another probe is started and sends an alert signal to the data center 40 by the data transceiver 30.

The data transceiver 30 receives the parking information and the state of the parking space 200 from the monitor 20 and transmits the information to the data center 40 by a communication network such as GPRS, 3G, or a wired connection.

The data center 40 includes a database 41, a parking space management unit 42 and a wireless communication unit 43, a storage unit 44, and a processor 45.

The database 41 includes the parking information and the state of each parking space 200 transmitted from the transceiver 30 and any standard or other financial rates of the parking area stored in the storage unit 44.

The parking space management unit 42 comprises one or more software programs stored in the storage unit 44 and can be executed by the processor 45 to manage the parking spaces 200.

In one exemplary embodiment, the parking space management unit 42 includes a parking space reserving module 421, a parking space searching module 422, and a parking fee searching module 423.

The parking space reserving module 421 is configured to receive a request for a parking space or a request to reserve a parking space, sent from a car owner by a mobile terminal The parking space reserving module 421 further processes the parking space enquiry or reservation.

When the car owner reserves a designated parking space, the parking space reserving module 421 obtains the state of the designated parking space from the database 41. If the designated parking space is occupied, such as a designated parking space numbered as 01, the parking space reserving module 421 notifies the car owner by means of audio, messages, or email, that the reservation of designated parking space is not possible such that the car owner should reserve an alternative parking space. Otherwise, if the designated parking space is vacant, the parking space reserving module 421 updates the state of the designated parking space to be reserved, notifies the parking space management department to reserve the designated parking space for the particular car, and notifies the driver that the designated parking space has been successfully reserved.

When the car owner reserves an undesignated parking space which may be any vacant parking space, the parking space reserving module 421 obtains information as to the vacant parking spaces according to the states of all of the parking spaces stored in the database 41 and sends the information to the car owner. The car owner can choose one of the vacant parking spaces and reply to the information by indicating a chosen parking space to the parking space reserving module 421. The parking space reserving module 421 updates the state of the chosen parking space to occupied, notifies the parking space management department to reserve the chosen parking space for the car owner, and also notifies the car owner that the chosen parking space has been successfully reserved. In addition, the parking space reserving module 421 can also send information as to the location of the reserved parking space to the car owner to guide the car owner to the location.

The parking space searching module 422 is configured to receive a parking space search sent from the car owner by the mobile terminal. The parking space searching module 422 searches all the parking spaces and sends the result of search to the car owner. The car owner can decide whether to enter into the paring area according to a result of search. For example, if all of the parking spaces are occupied, the car owner can choose some other parking area, but if some parking spaces are vacant; the car owner can obtain the location of the vacant parking space to park without wasting any time.

The parking fee searching module 423 is configured to receive an enquiry as to parking fees which has been sent from the car owner and obtains parking fees according to parking rates of charge stored in the database 423.

The wireless communication unit 43 is configured to establish communication between the car owner and the data center 40. The wireless communication unit 43 may be a BLUETOOTH communication module or a WIFI communication module.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of computer-readable medium or other storage device.

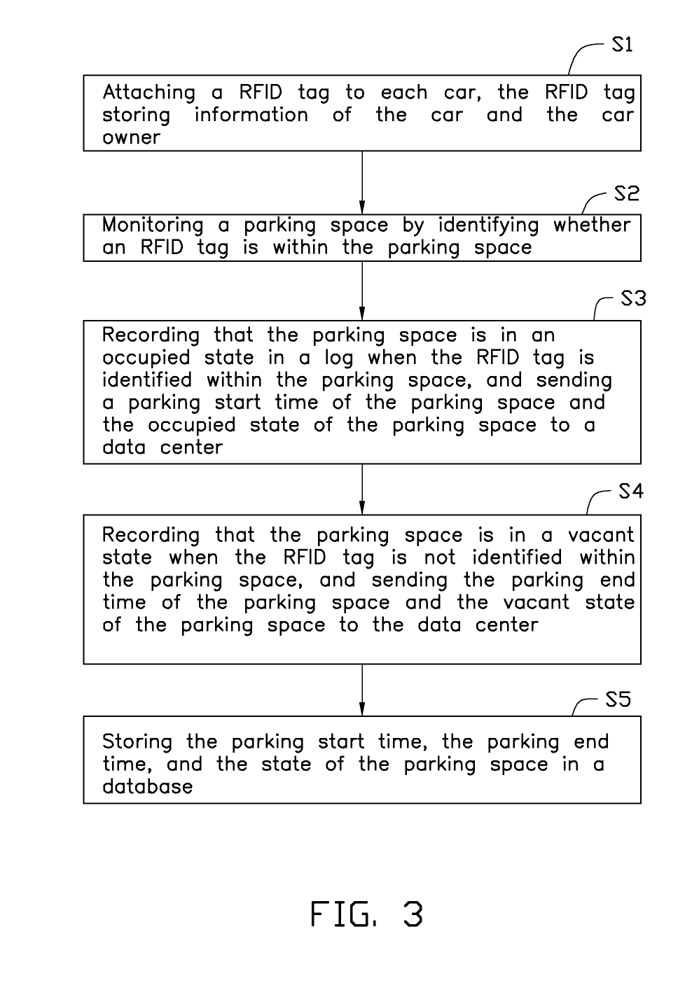

Referring to FIG. 3, a parking monitoring process of the monitoring system 100 may include following steps:

In step S1, an RFID tag 10 is attached to a car which needs to enter into the parking area. The RFID tag 10 may be a card integrated with an RFID microchip attached to the car.

In step S2, the monitor 20 of the parking space 200 monitors the parking space 200 by identifying whether the RFID tag 10 is within the parking space 200.

In step S3, when the monitor 20 makes contact with and identifies the RFID tag 10 within the parking space 200, the monitor 20 records the parking start time of the parking space 200 and also records that the parking space 200 is occupied in the database 41 or in a log. The monitor 20 sends the parking start time of the parking space 200 and the occupied state of the parking space 200 to the data center 40.

In step S4, when the monitor 20 identifies that the RFID tag 10 is no longer within the parking space 200, the monitor 20 records the parking end time of the parking space 200 and also records the vacant state of the parking space 200. The monitor 20 sends the parking end time of the parking space 200 and the vacant state of the parking space 200 to the data center 40.

In step S5, the data center 40 receives the parking start time and the parking end time, and the state of the parking space 200 from the monitor 20, and stores the above-mentioned information in the database 41.

The monitoring system 100 monitors the parking spaces 200 by means of the monitors 20 and reserves or searches the parking spaces 200 according to the parking information monitored by monitors 20 so that a car owner can park conveniently and effortlessly.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A monitoring system for a parking space, comprising:
a monitor corresponding to the parking space and positioned at the parking space, the monitor recording a state of the parking space, the state comprising an occupied state and a vacant state; when the monitor identifies an RFID tag within the parking space, the monitor recording the occupied state of the parking space; when the monitor identifies the RFID tag is no longer within the parking space, the monitor recording the vacant state of the parking space;
a data transceiver; and
a data center, the data center communicating with the monitor using the data transceiver, and storing the vacant state and/or the occupied state of the parking space.

2. The monitoring system of claim 1, wherein the data center comprises a storage unit, a processor, a wireless communication unit, and one or more programs stored in the storage unit and executed by the processor, the one or more programs comprises a database and a parking space management unit; the database stores the state of the parking space, the parking space management unit receives a request to reserve the parking space from a car owner by the wireless communication unit and executes the request according to the vacant state and/or occupied state of the parking space stored in the database.

3. The monitoring system of claim 2, wherein if a designated parking space is in the occupied state, the parking space reserving module notifies the car owner that the reservation of designated parking space is not possible.

4. The monitoring system of claim 2, wherein if a designated parking space is in the vacant state, the parking space reserving module updates the state of the designated parking space to be in the occupied state, notifies a parking space management department of the parking space to reserve the designated parking space for the car owner, and notifies the car owner that the designated parking space is successfully reserved.

5. The monitoring system of claim 2, wherein when an undesignated parking space is reserved by the car owner, the parking space reserving module obtains information of vacant parking spaces according to states of all of parking spaces stored in the database, sends the information of the vacant parking spaces to the car owner, updates a state of a chosen parking space to be in the occupied state according to a reply from the car owner, notifies a parking space management department of the parking space to reserve the chosen parking space for the car owner, and notifies the car owner that the chosen parking space is successfully reserved.

6. The monitoring system of claim 5, wherein when the chosen parking space reserving module is successfully reserved, the parking space reserving module sends location information of the reserved parking space to the car owner.

7. The monitoring system of claim 4, wherein the parking space reserving module sends location information of the reserved parking space to the car owner.

8. The monitoring system of claim 5, wherein the parking space management module further comprises a parking space searching module, the parking space searching module receives a parking space searching requirement sent from the car owner, searches the states of all parking spaces or the state of the designated parking space and sends a searched result to the car owner.

9. The monitoring system s of claim 5, wherein the parking space management module further comprises a parking fee searching module, the monitor records a parking start time of the parking space when the RFID tag is identified within the parking space and records a parking end time of the parking space when the RFID tag is not identified with the parking space, the parking fee searching module receives a parking fee searching requirement sent from the car owner and obtaining a parking fee according to a parking duration time based on the parking start time, the parking end time and a parking charging standard stored in the database.

10. A computer-implemented monitoring method, comprising:
monitoring a parking space by identifying whether an RFID tag is within the parking space;
recording that the parking space is in an occupied state in a log when the RFID tag is identified within the parking space, and sending a parking start time of the parking space and the occupied state of the parking space to a data center; and
recording that the parking space is in a vacant state when the RFID tag is not identified within the parking space, and sending a parking end time of the parking space and the vacant state of the parking space to a data center.
